(19) United States
(12) Patent Application Publication
(10) Pub. No.: US 2018/0039351 A1
(43) Pub. Date: Feb. 8, 2018

(54) METHODS AND APPARATUS FOR METAL TOUCH SENSOR

(71) Applicant: Texas Instruments Incorporated, Dallas, TX (US)

(72) Inventors: Ling ZHU, Shanghai (CN); Lixin CHEN, Shanghai (CN); KangCheng XU, Shanghai (CN); Wei ZHAO, Shanghai (CN)

(21) Appl. No.: 15/373,929

(22) Filed: Dec. 9, 2016

Related U.S. Application Data
(63) Continuation of application No. PCT/CN2016/093882, filed on Aug. 8, 2016.

(51) Int. Cl. G06F 3/044; G06F 3/046

(52) U.S. Cl. CPC G06F 3/044; G06F 3/046

(57) ABSTRACT

In described examples, an apparatus includes a metal plate having a plurality of defined areas forming touch sensors on a first planar surface, and having an opposing planar surface. The metal plate is arranged to be deformable in the plurality of defined areas by a human touch. A circuit board has a plurality of conductive sensors on a first surface arranged with the plurality of conductive sensors facing and spaced from the opposing planar surface of the metal plate, the conductive sensors placed in correspondence with the defined areas on the metal plate so that deflection sensors are formed in the defined areas by the conductive sensors and the opposing planar surface of the metal plate. Methods are described.

### TECHNICAL FIELD

This application relates in general to touch sensors, and in particular to metal touch sensor devices.

### BACKGROUND

Touch sensors continue to replace mechanical devices such as buttons and switches as user inputs into electronic appliances. Example applications include consumer goods such as kitchen and laundry appliances, electronic door controls, and fan and AC controls, as well as industrial applications.

Capacitive touch sensors are often used. In one form of capacitive touch sensing, a single sensor acts as one plate of a variable capacitance. When a user's finger approaches the sensor, the user's finger acts as a second plate and a capacitance value can be detected corresponding to a touch. A non-conductive overlay will typically cover the sensors and protect the sensors. In an alternative arrangement, capacitors are formed of two plates placed in proximity and energized. When a user's finger approaches the sensor, the user's finger changes the electric field and the change can be detected.

Capacitive touch sensors with non-conductive overlays cannot sense a gloved touch. In many industrial and outdoor applications, the user may be wearing gloves. Capacitive touch sensors cannot operate properly when wet or when water is present. The sensors are susceptible to noise commonly found in AC powered systems. Covering a typical capacitive touch sensor with a protective metal layer renders the system inoperative.

Co-owned U.S. Pat. No. 8,624,871, entitled “Method and apparatus for sensing and scanning a capacitive touch panel,” naming Nihei et. al. as inventors, describes the use of capacitive touch panels with sensing electronics.

### SUMMARY

In described examples, an apparatus includes a metal plate having a plurality of defined areas forming touch sensors on a first planar surface, and having an opposing planar surface. The metal plate is arranged to be deformable in the plurality of defined areas by a human touch, and the metal plate has non-touch areas in areas other than the defined areas. A circuit board has a plurality of conductive sensors on a first surface arranged with the plurality of conductive sensors facing and spaced from the opposing planar surface of the metal plate, the conductive sensors placed in correspondence with the defined areas on the metal plate so that deflection sensors are formed in the defined areas by the conductive sensors and the opposing planar surface of the metal plate.

### BRIEF DESCRIPTION OF THE DRAWINGS

FIG. 1 is a diagram of a capacitor having two plates.

FIGS. 2A-2B are a diagram of a metal touch sensor detecting a deflection in a touch sensor using capacitive sensing, and an equivalent circuit diagram, respectively.

FIG. 3 illustrates a conventional metal touch sensor assembly using capacitive sensing.

FIG. 4 is a plan view of a first planar surface of a metal plate for a touch sensor having defined touch areas.

FIG. 5 shows in a projection of an opposing planar surface of a metal plate of an embodiment.

FIG. 6 shows in a projection a metal touch sensor embodiment incorporating the metal plate of FIG. 5.

FIG. 7 shows in a projection another embodiment for a metal touch sensor assembly.

FIG. 8 shows in another projection an alternative embodiment for a metal touch sensor.

FIG. 9 shows in a projection of an alternative metal touch sensor embodiment.

FIG. 10 illustrates in a circuit block diagram a processor coupled to a metal touch sensor.

FIG. 11 is a flow chart for a method embodiment.

FIG. 12 shows in a projection another metal touch sensor embodiment.

FIG. 13 shows in a projection the opposing planar surface of a metal plate for use in a metal touch sensor embodiment.

FIG. 14 shows in a projection the opposing planar surface of a metal plate for use in an alternative metal touch sensor embodiment.

### DETAILED DESCRIPTION OF EXAMPLE EMBODIMENTS

The figures are not necessarily drawn to scale. The term “coupled” may include connections made with intervening elements, and additional elements and various connections may exist between any elements that are described as “coupled.”

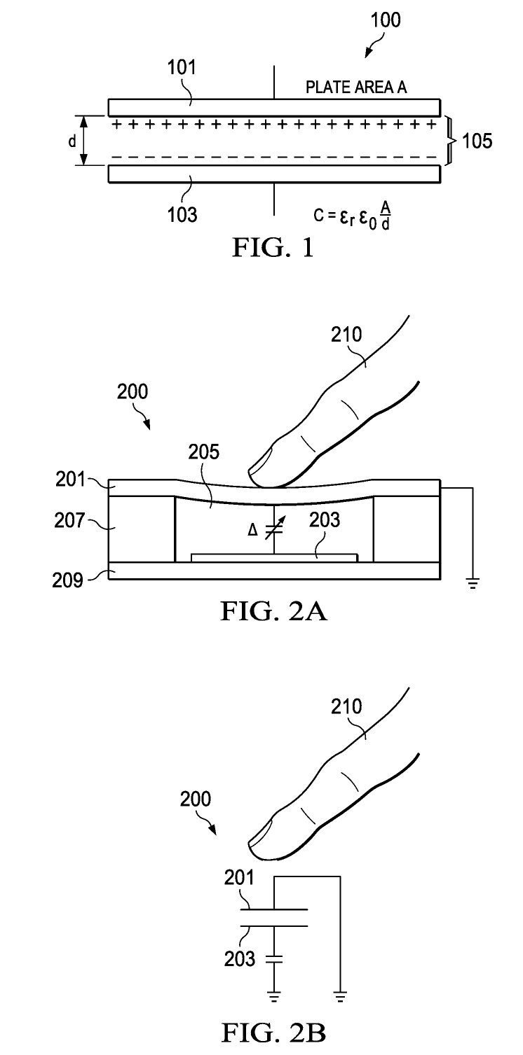

FIG. 1 illustrates in a cross sectional view a plate capacitor 100. In FIG. 1, capacitor 100 has an upper plate 101, which can be a metal conductive plate, and a lower plate 103 spaced from the upper plate. The plates 101, 103 have an overlapping surface area A. In the example of FIG. 1, an air dielectric 105 separates the upper and lower plates, although in alternative [symbol] arrangements other dielectric materials are used. The upper and lower plates are spaced from one another by a distance “d”.

The capacitance of the capacitor 100 is given in Farads by Equation 1:

C [symbol] r [symbol] o*A/d (1)

Without describing in detail the units and dielectric constants [symbol] r and [symbol] o, it is clear the capacitance in Farads is inversely proportional to the distance d between the plates. A change in distance d therefore changes the capacitance. The metal touch sensor takes advantage of this change in distance to detect a touch.

FIGS. 2A-2B illustrate a metal touch sensor and a corresponding equivalent circuit schematic. In FIG. 2A, a sensor 200 includes a conductive metal plate 201 having a first planar surface for receiving a touch and opposing planar surface on an opposite side, a circuit board PCB 209, a sensor pad 203 on a first surface of the circuit board 209. A spacer 207 keeps the opposing surface of the metal plate 201 at a predetermined distance from a circuit board 209. The circuit board 209 carries sensors 203 on a first surface. The sensors can be of copper, and may be a copper foil or copper electroplated layer that is patterned. In an example, the area of sensor 203 is larger than the end of a human finger and it may be around 100 mm². The opening in the spacer 207 can be larger than the sensor area. A larger opening in spacer 207 can enable a larger deflection in the metal plate.

The metal plate has to be of a thickness that allows a deflection due to a human touch. As shown in FIG. 2A, when the pressure of a human finger is applied to the metal plate 201, it deflects and a change in capacitance proportional to the change in the distance “d” can be detected. By application of a sensing voltage to the bottom plate of the capacitor, which is the sensor 203, a capacitance value can be obtained. By repeatedly scanning a plurality of sensors, a system can detect changes in capacitance and thereby detect a touch. The sensors 203 detect deflections in the metal plate 201 caused by a finger or stylus moving the metal plate 201 towards the sensor 203. The capacitive sensors 203 therefore form deflection sensors.

The spacer 207 must be rigid. Deflections in areas between the designated touch areas can result in false touch detections. A movement in the metal plate in a touch area that is away from the area actually being touched can also cause a false touch detection. The spacer must be adhered to the metal plate 201 to prevent adjacent areas of the metal plate 201 that are away from the touch from deflecting while a designated touch area is deflected.

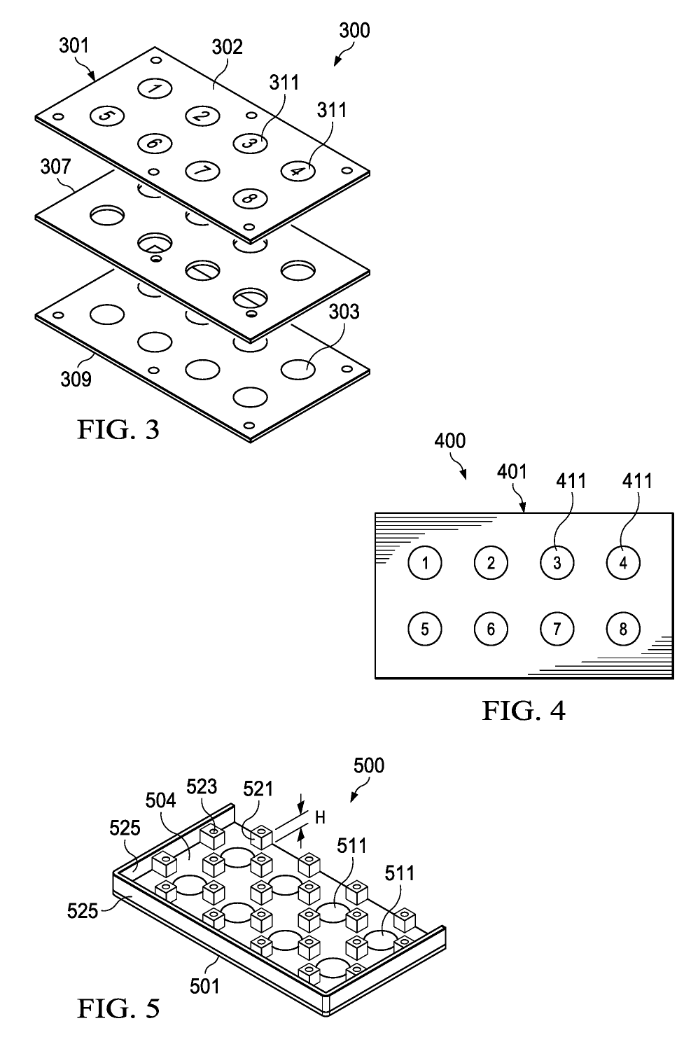

FIG. 3 illustrates in a projection view a conventional metal touch sensor 300. In FIG. 3, some components are similar to those of FIG. 2 and for those components, similar reference labels are used, for clarity. For example, the metal plate 201 corresponds to metal plate 301 in FIG.3. In FIG. 3, a first planar surface 302 of a metal plate 301 forms an exterior of the touch sensor. Spacer 307 is beneath an opposing planar surface of metal plate 301 (not visible in the projection of FIG. 3) and a circuit board 309 is d beneath spacer 307. Sensors 303 on the circuit board 309 are positioned facing and in corresponding to the defined touch areas 311 on the first planar surface of metal plate 301. The circuit board 309 and sensors 303 are spaced from the opposite planar surface of metal plate 301 by the spacer 307.

The “buttons” 311 on the first planar surface 302 of metal plate 301 are not physically separate from the rest of the first planar surface of the metal plate 301, but instead are designated areas for sensing touch. The designated areas 311 can be indicated by decals, paint, screen-printing, etching or dyes to color the metal differently from the surrounding non-touch areas. Other visual cues can be used to indicate where the defined touch areas are. Sensors 303 form a bottom plate of capacitors with the opposite planar surface (not visible in FIG. 3) of metal plate 301 forming the top plate in the designated touch areas. The sensors 303 and the opposing surface of metal plate 301 form deflection sensors. A deflection in a designated touch area 311 can be detected due to a change in capacitance at one of the sensors 303. Sensing circuitry (not shown in FIG. 3) that can include analog to digital converters, analog front ends, and digital processors, can determine when a particular sensor changes capacitance, and by determining which one of the sensors changed capacitance, a touch can be identified. Scanning of the sensors can be used to continuously check for a deflection in the metal plate 301.

Conventional touch sensors such as 300 in FIG. 3 have several problems that need to be improved. A touch in a non-touch area can deflect the metal plate enough so that the proximate sensors such as 303 in FIG. 3 can erroneously detect a deflection, indicating a touch. The erroneous deflection results in a false touch detection, and can lead to a false data entry. The spacer 307 adds costs and materials and the spacer materials can become detached from the metal plate 301, causing additional deflections in the areas not being touched. A metal touch sensor that does not detect false touches is needed.

FIG. 4 illustrates in a top view a metal plate 401 for use in a touch sensor embodiment. In FIG. 4, buttons 411 indicate designated areas for receiving a human touch. The metal plate 401 can be any appropriate conductive metal that can returnably deform in response to a human touch or stylus. The metal plate has to be able to deflect a distance sufficient to cause a change in the capacitance value associated with a sensor that can be reliably detected, and the metal plate must be able to return to the original position. This action of deflection and return must be repeatable for thousands or millions of times without changing the normal position of the metal plate. Metals such as stainless steel and aluminum can be used. While the thickness needed to facilitate the deflection and return depends on the material and the overall size of the areas designated as touch areas, an example is an aluminum metal plate 301 having a thickness of 0.5 millimeters with a sensor 20 mm in diameter. Larger touch areas and larger sensor areas will provide additional sensitivity, but larger sensors also result in additional area needed, so a design tradeoff exists.

In FIG. 4, the designated areas for touch are shown as a plurality of numerical buttons. The interpretation of the meaning of a touch is very flexible and is system dependent. Characters can be used such as letters, symbols, words such as “STOP”, “START”, and international symbols for power on/off. A processor such as a microcontroller, microprocessor, digital signal processor, or central processing unit can receive a signal indicating the touch detection. The processor can be programmed to perform desired actions in response to the touch. Visual feedback such as illuminating an LED or showing a character on a panel in response to the touch can be used. This positive feedback can assure a user that the touch has been received. Haptic feedback such as vibration can be used. Other feedback indications such or light or sound in response to the touch can assist users in entering data using the touch sensor.

FIG. 5 illustrates in a projection view 500 a reverse side of a metal plate 501 for use in an embodiment. The opposing planar surface or reverse side 504 is the reverse of the first planar surface shown in the example metal plate 401 of FIG. 4, and includes other features. The areas 511 correspond to the reverse of the designated touch areas 411 in FIG. 4. The circular areas 511 shown in FIG. 5 are blind holes that implement the spacer for metal touch. When the touch sensor is assembled, the depth of the blind holes provide the spacing distance between the bottom surface of the metal plate in the touch areas and the sensors on the printed circuit board, which are placed adjacent to the reverse surface 504 of the metal plate 501. The depth of the blind holes can vary. In an example, the depth ranged from 0.1-0.2 millimeters.

In FIG. 5, posts 521 are shown extending away from the opposing planar surface 504 of metal plate 501 a distance H. The posts 521 can be formed integral to the metal plate 501. In an alternative arrangement, the posts 521 can be mounted on metal plate 501 and secured, such as by brazing or epoxy. Metal plate 501 can be stamped, bent, or molded. Each post 521 has a hole 523 formed in an exposed surface, the hole 523 extending back towards the metal plate 501.

In FIG. 5, the metal plate 501 includes flange portions 525. The flange portions 525 are at the outer edges of metal plate 501 and form rigid sides. The flange portions can be formed with the metal plate 501 and can be integral to it. Metal plate 501 and flanges 525 can be formed in a metal stamping operation. In an alternative example, the flange portions can be formed separately and attached by brazing, welding or epoxy.

In FIG. 5, the circular outlining areas 511 are blind holes that implement the spacer for metal touch. The depth of the blind holes defines the spacing distance “d.” When the metal plate 501 is used in a touch sensor assembly as described hereinbelow, the depth of the blind holes 511 will set the distance between the sensors on the circuit board and the opposing planar surface 504 of metal plate 501, and thus define the capacitance value when there is no deflection in a designated touch area.

The posts 521 are positioned surrounding the circular blind holes 511 in the designated touch areas. The non-touch areas between the designated touch areas are supported by the posts 521, so that a touch in a non-touch area will not cause a deflection in metal plate 501. The posts 521 can therefore prevent a false touch detection, since no deflection in the metal plate 501 will occur when these non-touch areas are touched.

The holes 523 extending into the posts 521 can also be blind holes. In an alternative arrangement, the holes can be machined to receive screws or bolts. In an example arrangement, the holes 523 can receive rivets or brads. Epoxy can be used to secure the brads to the holes.

In another alternative arrangement, the posts 521 can end in an extension portion (not shown in FIG. 5) that extends into a receiving hole in a back panel and is secured by other means. The posts 521 provide a place for a fastener component to join the assembly together, and prevent deflection of metal plate 501 in the non-touch areas.

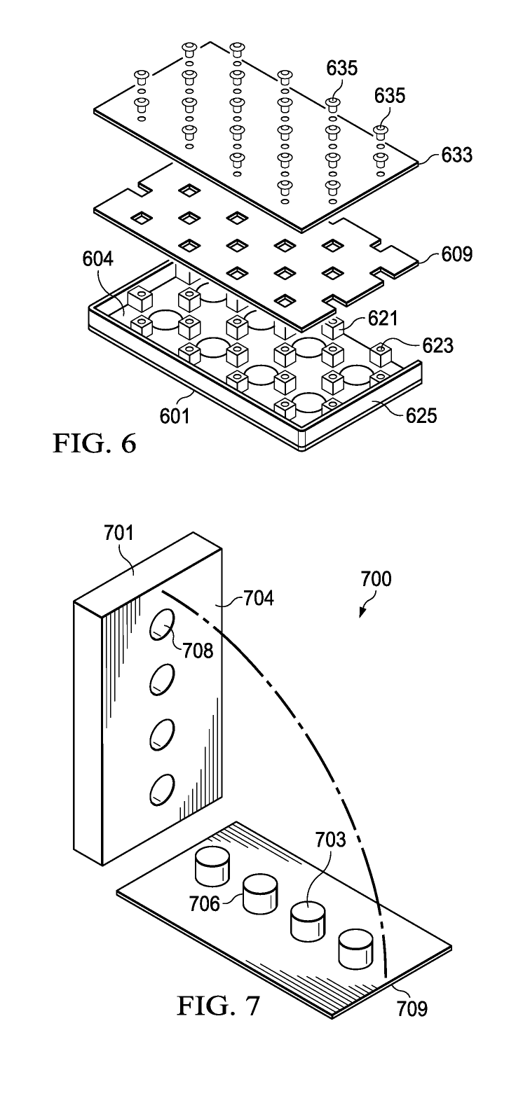

FIG. 6 shows in a projection view a metal touch sensor embodiment 600. In FIG. 6, the metal plate 601 is similar to the metal plate 501 in FIG. 5. Similar reference labels are used for those components in FIG. 6 that are similar to those shown in FIG. 5, for clarity. For example, flanges 625 in FIG. 6 correspond to flanges 525 in FIG. 5. In FIG. 6, metal plate 601 has a first planar surface (not visible in the view in FIG. 6) with designated areas for touch sensors. In FIG. 6, the opposing planar surface 604 is shown with posts 621 extending away from the opposing planar surface 604. The posts 621 are shown with holes 623 extending into the posts towards the opposing planar surface 604. The holes 623 are arranged to receive fastener components. In FIG. 6, the joining components 635 are shown positioned for insertion into the holes 623 in posts 621. A circuit board 609 is shown positioned with a first surface (not visible in the projection of FIG. 6) carrying sensors (also not visible in FIG. 6) that are placed spaced from and opposing designated areas for touch on metal plate 601.

A back cover 633 is shown overlying a second surface of circuit board 609 and is arranged to be secured to the assembly 600 by the joining components 635. The back cover can be formed of two pieces, and can include a non-conductive spacer (not shown in FIG. 6) that has openings similar to those in circuit board 609 to allow the posts 621 to extend through the spacer. In an example an acrylic spacer was used. In an alternative, the back cover 633 can be a thicker single piece as shown in FIG. 6 and can be a conductive metal. In another alternative, the circuit board 609 can be thicker than the height of posts 621, in which case the spacer is not needed. In the example shown in FIG. 6, the circuit board 609 has openings to allow the posts 621 to extend through the circuit board to receive the fasteners. The fasteners 635 will extend through the holes in back cover 633 and into the holes 623 in the posts 621. The openings in circuit board 609 should be a bigger size than the cross-sectional area of posts 621 so that the circuit board 609 can be inserted with the posts 621 extended out of the circuit board 609.

The backing cover 633 is used to press the surface of circuit board 609 close to opposing planar surface 604 of metal plate 601. In an example, the backing cover 633 includes an acrylic spacer (not shown) and a metal cover. The thickness of the acrylic spacer plus the thickness of circuit board 609 should be bigger than the height of posts 621. When the assembly 600 is complete, the fastener components 635 will be inserted into the holes 623 in posts 621, will join the circuit board 609 to the metal plate 601, and will join the backing cover 633 to complete the assembly 600. The spacing between the sensors on the circuit board (not visible in this view) and the opposing planar surface 604 of metal plate 601 will be maintained by the depth of blind holes 511 (see FIG. 5).

In this example, the fastener components 635 can be screws, rivets, brads, or pins inserted into the holes 623 in posts 621. The fastener components may be mechanically coupled to metal plate 601 by rotation into threaded holes, in the case of screws, or by expansion into a blind hole, in the case of rivets. Epoxy or other adhesives can be used to secure the fastener components 635 to the posts 621. In an alternative arrangement (not shown in FIG. 6), the posts 621 can include an extended central portion that extends through the circuit board 609 and is secured to the backing component 633 using holes in 633 or by other securing methods.

The circuit board 609 can be of any material used for carrying circuitry and conductive traces such as “greenboard” or FR4. Single layer, dual layer and multilayer printed circuit boards can be used. Laminate substrate materials for circuitry can be used. Other layers suitable for forming circuitry including conductive sensors can be used. The backing cover 633 can be any material that is protective and provides durable mechanical support, including plastic, FR4, fiberglass, or metal. The assembly 600 can be hermetically sealed. The assembly 600 can be made water resistant or waterproof. Protective covering layers can be used with both the first planar surface of metal plate 601, the backing cover, and the flanges. Because the change in capacitance that is sensed is due to a deflection of metal plate 601, use of a covering material does not interfere with the touch detection. Gloves, styli, and other pointing devices can be used to deflect the metal plate 601 in the designated touch areas.

The embodiment in FIG. 6 prevents false touch detection by securing the non-touch areas to the posts, so that an inadvertent touch in a non-touch area does not cause a deflection in the metal plate that can be detected by the sensors.

FIG. 7 shows in a projection view an alternative embodiment 700. In FIG. 7, a metal plate 701 is shown with four example designated areas for touch sensors 708. Each designated area 708 has a blind hole extending into the metal plate 701. The metal plate 701 has a first thickness great enough to prevent deflection by a human touch. The blind holes 708 extend into the metal plate 701 and form a designated area in metal plate 701 that is thin enough that it can be repeatedly and returnably deformed by a human touch. Since the metal plate 701 is relatively thick in areas that are not designated areas for touch sensors, no deflection will occur in these areas when touched, and no false touch detection is possible.

To complete the capacitive sensors for the embodiment in FIG. 7, sensors 703 are placed on a top portion of pillars 706 extending into the blind holes 708 to set a spacing distance between the sensors and the bottom surface of the metal plate 701 (not visible in FIG. 7) in the blind holes. This spacing becomes the distance “d” between the capacitor plates.

A circuit board 709 has pillars 706 that extend into the blind holes 708 and support the sensors 703. Although not shown in FIG. 7 for clarity, electrical connections are formed between the sensors 703 and the remaining circuitry on the circuit board 709. Vertical conductive vias can be formed in the pillars 706. Alternatively, wires or copper conductors formed on the pillars can extend vertically to complete the connections.

The bottom planar surface of metal plate 701, labeled 704, will contact the upper surface of circuit board 709 and can be adhesively or mechanically joined to complete the assembly 700. As the metal plate 701 has a thickness so great that it cannot be deflected by human touch in non-touch areas, no false touch will be detected using this arrangement.

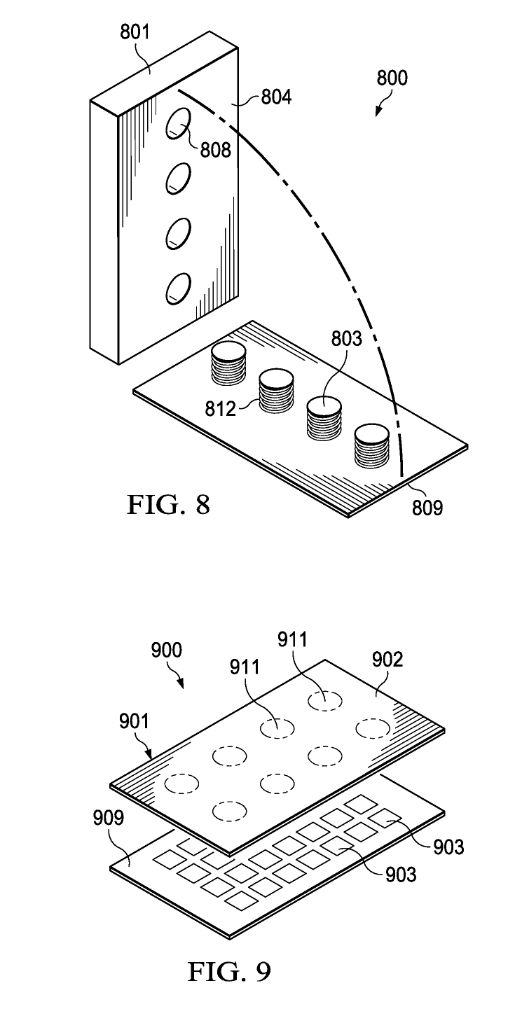

FIG. 8 shows in another projection an alternative embodiment 800. In FIG. 8, a metal plate 801 similar to metal plate 701 is shown. Metal plate 801 has a thickness great enough that it is not deformable by human touch. A first planar surface (not visible in the view in FIG. 8) provides designated areas for touch sensors. A plurality of blind holes 808 are formed extending into the metal plate 801 from the opposing planar surface 804. The blind holes 808 extend into metal plate 801 leaving a thin portion having a second smaller thickness in metal plate 801 that is thin enough to be returnably deformed by human touch. The deflections in these designated areas for touch will cause a change in capacitance in these touch sensor areas.

In FIG. 8, conductive springs 812 are shown arranged in correspondence with the blind holes 808. The conductive springs support sensors 803 positioned on a top portion of the springs 812. The conductive springs 812 are electrically coupled to the sensors 803 and to additional circuitry on the circuit board 809. A spacing distance is formed by inserting the springs 812 and the sensors 803 into the blind holes 808, the sensors being placed in a position facing the opposing surface of metal plate 801 in the designated areas so that the portion of the metal plate 801 forms one plate of a capacitor, and the sensors form another plate. Placing the sensors into the blind holes in close proximity to the reverse surface (not shown) of plate 801 in the designated areas increases the capacitance and increases the sensitivity of the capacitive sensors to changes caused by deflection in plate 801.

Because plate 801 cannot be deflected by a human touch in non-touch areas, no false touch detections occur due to touches in these areas.

FIG. 9 shows in another projection view an additional alternative embodiment 900. In FIG. 9, a metal plate 901 is spaced from and overlying a circuit board 903. A plurality of designated touch areas 911 are indicated on a first planar surface 902 of metal plate 901. However, the designated touch areas 911 are not different from other areas on the first planar surface 902, other than the designated touch areas are painted or labeled with visual indicators for a user. The designated touch areas 911 can appear as buttons or as other shapes. The designated touch areas can be indicated by paint, screen-printing, decals, etching, dyes and other coloration of the metal plate 901. A plastic overlay can carry the visual indicators showing the user where the designated touch areas are on the upper planar surface 902 of the metal plate 901.

In the embodiment 900, software emulation is used to distinguish a touch in a designated touch area from a touch in other areas. The sensors 903 are arranged in an array of rows and columns, spaced from and facing the opposing planar surface (not visible in FIG. 9) of the metal plate 901. A processor and additional circuitry coupled to or located on the circuit board 903 emulates the touch areas and the non-touch areas. When a touch is detected by a change in capacitance indicating a deflection in metal plate 901 at one or more of the sensors 903, the processor performs a method for determining which of the designated touch areas 911 the touch corresponds to. If the touch is between two designated areas, the processor makes a determination using probability and the proximity of the active sensors to the designated touch areas as to whether or not the touch is in a designated touch area. If the processor finds the touch is not in a designated touch area, the touch is disregarded as a false touch.

In the embodiment 900 of FIG. 9, the metal plate can be deflected by a human touch in designated areas 911 and in other areas. By using a software emulation approach, the posts, screws, or blind holes as used in the embodiments of FIGS. 6-8 are not needed. The metal plate 901 can have a uniform thickness and need not have posts or other shapes or blind holes formed in it. The thickness of metal plate 901 is chosen so that the metal plate 901 can be returnably deformed in an area corresponding to a sensor area by a human touch.

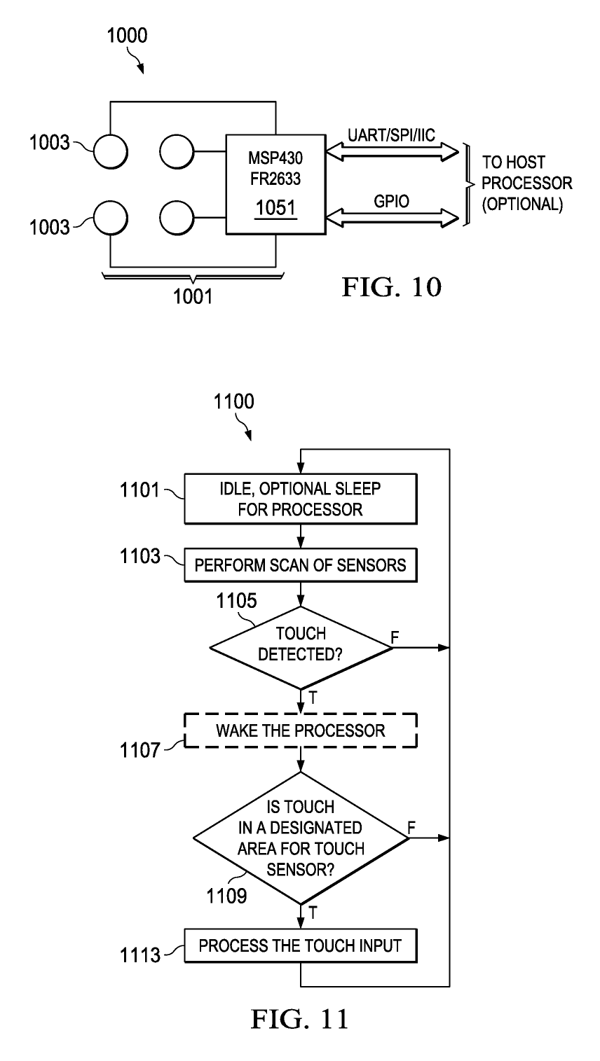

FIG. 10 illustrates in a circuit schematic a system embodiment 1000. In FIG. 10, a touch sensor 1001 includes sensors 1003 that are coupled to a mixed signal processor 1051. Mixed signal processors (MSPs) produced specifically for use with touch sensors are provided by Texas Instruments Incorporated. As an example, the device designated MSP430FR26XX from Texas Instruments Incorporated integrates a programmable microcontroller with a dedicated analog to digital converter and with built in scan I/Os in a single device. This programmable MSP device can operate in a low power mode where the capacitive sensors are scanned while the processor and other functions “sleep”. When a touch is detected, the device “wakes up” and begins processing the touches detected. Ultra-low power processors are particularly important for applications powered by batteries. Texas Instruments Incorporated provides other integrated circuits arranged specifically for touch sensor applications that can be used with the embodiments. In alternative examples, other microprocessors, micro-controllers, digital signal processors, and analog to digital converters can be used to form the circuitry of FIG. 10. Application specific integrated circuits (ASICs), field programmable gate arrays (FPGAs), and complex programmable logic devices (CPLDs) can also be used to form the processor 1051. Processor 1051 includes non-volatile program memory stored in FLASH, EEPROM, or FRAM that can be used to store instructions for the microcontroller or processor to execute. Processor 1051 includes communications ports labeled UART/SPI/IIC and GPIO for coupling the dedicated processor 1051 to the remaining circuitry of the system.

In operation, the processor 1051 can provide the software emulation needed to eliminate false touch detection using an array of sensors such as 1003 on a circuit board mounted to a metal plate. When a touch is detected, the processor can determine which sensor or sensors are touched. The processor can then determine whether the sensor or sensors are located in a position that corresponds to a designated touch area. If the touch is in an area that is not a designated touch area, then this touch is a false touch and can be ignored.

FIG. 11 illustrates in a flow diagram a method embodiment 1100. In FIG. 11, the method begins at step 1101, Idle. In an example, a processor can optionally be put in a low power or sleep mode in this step. In an alternative example, the processor can remain active in this step. At step 1103, which can be performed periodically from step 1101, the sensors are scanned. In scanning the sensors, a change in capacitance is detected for any sensors where the metal plate overlying the sensors is deflected by a touch.

At step 1105, a touch detected? determination is made. If the sensor scan did not result in any sensors indicating a touch, the method returns to step 1101, Idle, and continues.

If a touch was detected and the determination in step 1105 is true, then the method transitions to step 1107. This optional step indicates the processor should wake (if in a sleep mode). At step 1109, a second determination is made. Using the sensors that were active in step 1105, a decision is made as to whether the touch corresponds to a designated area for touch in the touch sensor. If the decision is false, then the touch is in an area not designated for touch, and it can be ignored. In that case the method transitions back to step 1101, Idle.

If the determination at step 1109 is true, the method transitions to step 1113, where the touch is processed as a valid user input. Actions can be taken or the touch information can be stored awaiting additional touch input. For example, in a security application, several touch inputs may be needed to enter a code or password before the system can evaluate whether the code or password matches a stored code or password.

By providing a method to distinguish false touches from touch inputs at a designated area, and by ignoring false touches at a metal sensor, the method of FIG. 11 emulates in software the function of the posts in the embodiment shown in FIGS. 5 and 6; without the need for adding posts to the metal plate.

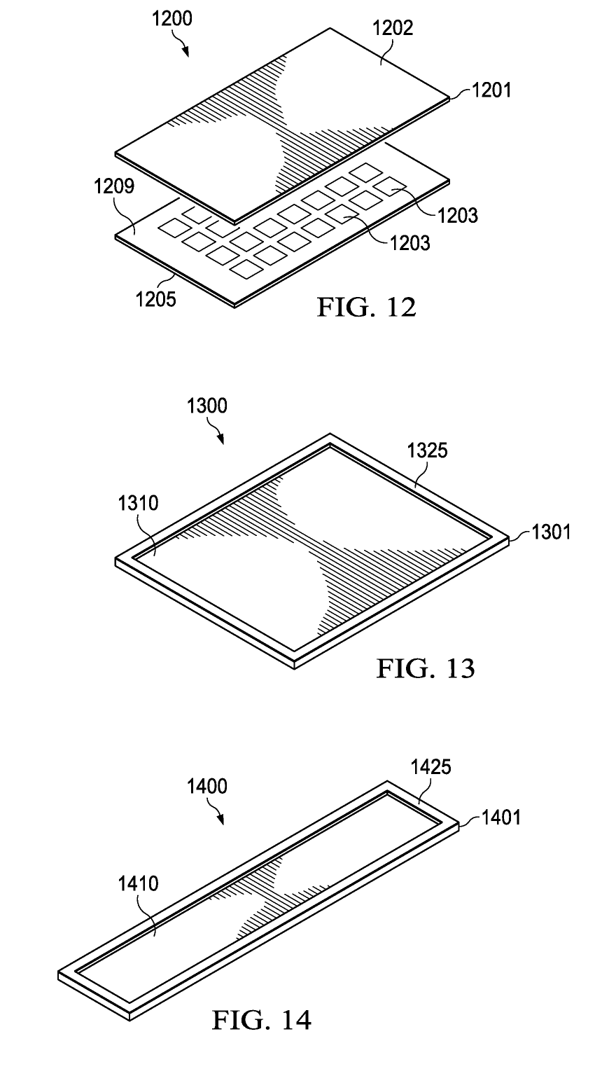

FIG. 12 shows in another projection view an additional embodiment. In FIG. 12, a metal plate 1201 provides an upper planar surface 1202 for receiving touch inputs. A circuit board 1209 includes a plurality of sensors 1203 arranged in rows and columns and can include additional circuitry such as processors and analog to digital converter circuitry to collect and process signals from the sensors.

The metal plate 1201 can be a touch sensor that can receive input in the form of gestures such as a swipe or loop or diagonal or parallel line drawn by human touch. When the sensors sense a change in capacitance due to the deflection of the metal plate, the deflection can be detected as a gesture. By analyzing the changes in capacitance in multiple sensors, and by determining the order of the sensors that were affected, a touch movement can be interpreted as an input.

FIG. 13 depicts in a projection a metal plate 1301 that is similar to the metal plate of FIG. 12. In FIG. 13, the opposite planar surface is shown. A recessed portion 1310 is formed corresponding to the sensor area, and a flange 1325 is formed surrounding the recessed portion 1310. The flange portion 1325 of the metal plate 1301 has a thickness greater than the portion of the metal plate in the recessed portion 1310. The flange thickness sets a spacer depth between the array of sensors (not shown in FIG. 13) on a circuit board and the opposing planar surface of the metal plate 1301.

FIG. 14 depicts in a projection view 1400 an alternative embodiment metal plate. In FIG. 14, a metal plate 1401 is shown that is configured for a sliding input. In FIG. 14, the opposing planar surface of the metal plate 1401 is shown, the upper planar surface of metal plate 1401 is not visible in this view. In FIG. 14, a flange 1425 surrounds a recessed portion 1410 that corresponds to the array of sensors on a circuit board (not shown in FIG. 14). The thickness of the flange portion 1425 again sets a spacer depth for the capacitive sensors. A user can input a touch input to the sensor shown in FIG. 14 by sliding a finger in a single motion. Sliding inputs to touch sensors are particularly useful for inputting variable settings such as volume and brightness.

In addition to the embodiments described, a wheel touch pad can be formed using the array of sensors such as sensors 1203 in FIG. 12. By making a motion in a circular direction in a designated area, a user can input a command. Fast forward and rewind commands for audio players and video players can be input using wheel sensors, for example. A visual pattern illustrating the wheel pattern can be printed on the upper planar surface of the metal plate to guide the user.

In the embodiments and examples described above, the sensors can be capacitive sensors with a pad or plate on the printed circuit board. In alternative arrangements that form additional embodiments, the sensors on the circuit board can be inductive sensors. A coil can be formed in the sensor area at each sensor position. An electric field can be formed around the coil. When the metal plate is deflected by a human touch, the change in the electric field can be detected and the deflection due to the touch can be detected.

In an example embodiment, an apparatus includes a metal plate having a plurality of defined areas forming touch sensors on an first planar surface, and having an opposing planar surface, the metal plate configured to be deformable in the plurality of defined areas by a human touch, and the metal having non-touch areas in areas other than the defined areas. The apparatus includes a circuit board having a plurality of conductive sensors on a first surface arranged with the plurality of conductive sensors, facing and spaced from the opposing planar surface of the metal plate, the conductive sensors placed in correspondence with the defined areas on the metal plate so that deflection sensors are formed in the defined areas by the conductive sensors and the opposing planar surface of the metal plate.

In a further example, in the apparatus, the metal plate has a first thickness and includes a plurality of blind holes extending into the metal plate at the opposing planar surface to provide a second thickness of the metal plate less than the first thickness in the plurality of defined areas. In still another example, the apparatus includes a plurality of pillars on the circuit board extending into the plurality of blind holes and having at least one of the plurality of conductive sensors at a top surface of the pillars facing and spaced from the opposing planar surface of the metal plate, a deflection sensor being formed between the at least one of the defined areas of the metal plate and at least one of the plurality of conductive sensors at the top surface of the pillar.

In yet another example, the apparatus includes a plurality of spring pillars on the circuit board extending into the plurality of blind holes in the metal plate and having at least one of the plurality of conductive sensors at a top portion of the spring pillars facing and spaced from the opposing planar surface of the metal plate, at least one deflection sensor being formed between the opposing planar surface of the metal plate in the defined areas and the at least one of the plurality of conductive sensors at the top portion of the spring pillars.

In still a further example, the apparatus includes a plurality of posts formed on the opposing planar surface of the metal plate and extending away from the opposing planar surface a predetermined distance, and blind openings extending into a top surface of the plurality of posts for receiving a fastener.

In yet another example, the apparatus includes the plurality of posts placed around the defined areas to prevent the metal plate from deforming in the non-touch areas.

In still another example, the apparatus includes fasteners inserted in the blind openings in the plurality of posts to join a backing component covering a second planar surface of the circuit board to the metal plate. In yet another example, the apparatus includes the fasteners selected from screws, rivets, brads and pins.

In another example, in the apparatus, wherein the metal plate is selected from stainless steel and aluminum. In yet another example, the conductive sensors are selected from capacitive sensors and inductive sensors.

In another alternative embodiment, an apparatus includes: a metal plate having at least one defined area forming a touch sensor on a first planar surface, and having an opposing planar surface, the metal plate being deformable in the defined area by a human touch on the first planar surface; and a recessed portion on the opposing planar surface of the metal plate having a recess depth. In the apparatus, the recess depth defines a spacing distance; and the apparatus includes flange portions surrounding the recessed portion on the opposing planar surface of the metal plate and not having the recess depth; a circuit board having a plurality of sensors on an upper surface, the sensors arranged in rows and columns, the plurality of sensors placed facing and in correspondence with the recessed portion of the opposing planar surface of the metal plate. In the apparatus, the flange portions contact the upper surface of the circuit board, and the sensors are spaced from the opposing planar surface of the metal plate by the spacing distance.

In still another example, in the apparatus, the touch sensor of the metal plate forms a gesture sensor area. In a further example, in the apparatus, the touch sensor of the metal plate forms a sliding sensor area. In yet another example, in the apparatus, the touch sensor of the metal plate forms a wheel sensor area.

In still an alternative example, in the apparatus the plurality of sensors comprise capacitive sensors that change capacitance when an area of the metal plate is deflected by a human touch. In yet another example, in the apparatus the plurality of sensors comprise inductive sensors that form an electric field that changes when an area of the metal plate is deflected by a human touch. In a further example, in the apparatus the defined area further include a plurality of defined button areas forming touch sensor buttons, spaced apart by areas on the metal plate forming non-touch areas. In yet another example, in the apparatus a processor is coupled to the sensors, and configured to detect a change in capacitance in the sensors indicating a touch deflecting the metal plate, and is configured to determine whether the touch is within a defined button area.

In a method embodiment, the method includes: defining a touch area on a first planar surface of a metal plate, the metal plate having a second planar surface opposing the first planar surface, the metal plate having a thickness in the touch area such that the metal plate can be deflected in the touch area by a human touch; placing a plurality of sensors on a circuit board disposed facing and spaced from the second planar surface of the metal plate; coupling the plurality of sensors to a processor configured to detect a signal from the sensors corresponding to deflection of the metal plate in the touch area due to a human touch; scanning the plurality of sensors to detect a deflection in the metal plate caused by a human touch; and operating the processor to determine where in the touch area the touch occurred.

In yet another alternative example, the method further includes defining touch button areas within the touch area on the first planar surface of the metal plate, and further defining non-touch areas; and operating the processor to determine whether a deflection in the metal plate detected by the plurality of sensors corresponds to a touch in a defined touch button area.

Modifications are possible in the described embodiments, and other embodiments are possible within the scope of the claims.

What is claimed is:

1. An apparatus, comprising:
a metal plate having a plurality of defined areas forming touch sensors on an first planar surface, and having an opposing planar surface, the metal plate configured to be deformable in the plurality of defined areas by a human touch, and the metal plate having non-touch areas in areas other than the defined areas; and
a circuit board having a plurality of conductive sensors on a first surface arranged with the plurality of conductive sensors facing and spaced from the opposing planar surface of the metal plate, the conductive sensors placed in correspondence with the defined areas on the metal plate so that deflection sensors are formed in the defined areas by the conductive sensors and the opposing planar surface of the metal plate.

2. The apparatus of claim 1, in which the metal plate has a first thickness and includes a plurality of blind holes extending into the metal plate at the opposing planar surface to provide a second thickness of the metal plate less than the first thickness in the plurality of defined areas.

3. The apparatus of claim 2, comprising:
a plurality of pillars on the circuit board extending into the plurality of blind holes and having at least one of the plurality of conductive sensors at a top surface of the pillars facing and spaced from the opposing planar surface of the metal plate, a deflection sensor being formed between the at least one of the defined areas of the metal plate and at least one of the plurality of conductive sensors at the top surface of the pillar.

4. The apparatus of claim 2, comprising:
a plurality of spring pillars on the circuit board extending into the plurality of blind holes in the metal plate and having at least one of the plurality of conductive sensors at a top portion of the spring pillars facing and spaced from the opposing planar surface of the metal plate, at least one deflection sensor being formed between the opposing planar surface of the metal plate in the defined areas and the at least one of the plurality of conductive sensors at the top portion of the spring pillars.

5. The apparatus of claim 1, in which the metal plate comprises a plurality of posts formed on the opposing planar surface of the metal plate and extending away from the opposing planar surface a predetermined distance, and having blind openings extending into a top surface of the plurality of posts for receiving a fastener.

6. The apparatus of claim 5, in which the plurality of posts are placed around the defined areas and are configured to prevent the metal plate from deforming in non-touch areas other than the defined areas.

7. The apparatus of claim 6, and further including fasteners inserted in the blind openings in the plurality of posts to join a backing component covering a second planar surface of the circuit board to the metal plate.

8. The apparatus of claim 7, in which the fasteners are ones selected from a group consisting essentially of screws, rivets, brads and pins.

9. The apparatus of claim 1, in which the metal plate comprises a metal selected from a group consisting essentially of stainless steel and aluminum.

10. The apparatus of claim 1, in which the conductive sensors are one selected from a group consisting essentially of capacitive sensors and inductive sensors.

11. An apparatus, comprising:
a metal plate having at least one defined area forming a touch sensor on a first planar surface, and having an opposing planar surface, the metal plate being deformable in the defined area by a human touch on the first planar surface;
a recessed portion on the opposing planar surface of the metal plate having a recess depth, the recess depth defining a spacing distance;
flange portions surrounding the recessed portion on the opposing planar surface of the metal plate and not having the recess depth;
a circuit board having a plurality of sensors on an upper surface, the sensors arranged in rows and columns, the plurality of sensors placed facing and in correspondence with the recessed portion of the opposing planar surface of the metal plate; and
the flange portions on the opposing planar surface of the metal plate contacting the upper surface of the circuit board, and the sensors being spaced from the opposing planar surface of the metal plate by the spacing distance.

12. The apparatus of claim 11, in which the touch sensor of the metal plate forms a gesture sensor area.

13. The apparatus of claim 11, in which the touch sensor of the metal plate forms a sliding sensor area.

14. The apparatus of claim 11, in which the touch sensor of the metal plate forms a wheel sensor area.

15. The apparatus of claim 11, in which the plurality of sensors comprise capacitive sensors that change capacitance when an area of the metal plate is deflected by a human touch.

16. The apparatus of claim 11, in which the plurality of sensors comprise inductive sensors that form an electric field that changes when an area of the metal plate is deflected by a human touch.

17. The apparatus of claim 11, in which the defined area further comprises a plurality of defined button areas forming touch sensor buttons, spaced apart by areas on the metal plate forming non-touch areas.

18. The apparatus of claim 17, and further comprising a processor coupled to the plurality of sensors, configured to detect a change in capacitance in the plurality of sensors indicating a touch deflecting the metal plate, and configured to determine whether the touch is within a defined button area.

19. A method for detecting a human touch at a metal touch sensor, comprising:
defining a touch area on a first planar surface of a metal plate, the metal plate having a second planar surface opposing the first planar surface, the metal plate having a thickness in the touch area such that the metal plate can be deflected in the touch area by a human touch;
placing a plurality of sensors on a circuit board disposed facing and spaced from the second planar surface of the metal plate;
coupling the plurality of sensors to a processor configured to detect a signal from the sensors corresponding to deflection of the metal plate in the touch area due to a human touch;
scanning the plurality of sensors to detect a deflection in the metal plate caused by a human touch; and
operating the processor to determine where in the touch area the touch occurred.

20. The method of claim 19, and further comprising:
defining touch button areas within the touch area on the first planar surface of the metal plate, and further defining non-touch areas; and
operating the processor to determine whether a deflection in the metal plate detected by the plurality of sensors corresponds to a touch in a defined touch button area.
